(19) United States
(12) Patent Application Publication
(10) Pub. No.: US 2018/0047038 A1
(43) Pub. Date: Feb. 15, 2018

(54) LEVERAGING HASHTAGS TO DYNAMICALLY SCOPE A TARGET AUDIENCE FOR A SOCIAL NETWORK MESSAGE

(71) Applicant: INTERNATIONAL BUSINESS MACHINES CORPORATION, ARMONK, NY (US)

(72) Inventors: Lisa Seacat DeLuca, Baltimore, MD (US); Jenny S. Li, Danbury, CT (US); Dana L. Price, Surf City, NC (US); Aaron J. Quirk, Cary, NC (US)

(21) Appl. No.: 15/233,174

(22) Filed: Aug. 10, 2016

(51) Int. Cl. G06Q 30/02; G06F 17/28; G06Q 50/00

(52) U.S. Cl. CPC G06Q 30/0205; G06Q 50/01; G06F 17/28

(57) ABSTRACT

A method for identifying a plurality of recipients of a social media correspondence is provided. The method may include receiving a correspondence from a user on a social media network that utilizes a hashtag. The method may also include identifying a subject and a location associated with the received correspondence using a plurality of natural language processing techniques. The method may further include identifying a target audience for the received correspondence based on the identified subject and the identified location. The method may also include transmitting the received correspondence to each individual within the identified target audience.

### BACKGROUND

The present invention relates, generally, to the field of computing, and more particularly to social media.

Social media may be a computer-related tool that allows users to interact through the exchange of information, such as videos, images, hyperlinks, and text, across the Internet. A social media service, or social networking service, may relate to a platform, such as an instant messaging service, a short messaging service, a blog, a website, or a community, that allows individuals within a social network to interact. Some social media services allow users to post content with a hashtag which allows for easier identification of the posted content by users with similar interests. A hashtag is a metadata tag typically used by a social media service to group related user posts together.

### SUMMARY

According to one embodiment, a method for identifying a plurality of recipients of a social media correspondence is provided. The method may include receiving a correspondence from a user on a social media network that utilizes a hashtag. The method may also include identifying a subject and a location associated with the received correspondence using a plurality of natural language processing techniques. The method may further include identifying a target audience for the received correspondence based on the identified subject and the identified location. The method may also include transmitting the received correspondence to each individual within the identified target audience.

According to another embodiment, a computer system for identifying a plurality of recipients of a social media correspondence is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a correspondence from a user on a social media network that utilizes a hashtag. The method may also include identifying a subject and a location associated with the received correspondence using a plurality of natural language processing techniques. The method may further include identifying a target audience for the received correspondence based on the identified subject and the identified location. The method may also include transmitting the received correspondence to each individual within the identified target audience.

According to yet another embodiment, a computer program product for identifying a plurality of recipients of a social media correspondence is provided. The computer program product may include one or more computer-readable storage devices and program instructions stored on at least one of the one or more tangible storage devices, the program instructions executable by a processor. The computer program product may include program instructions to receive a correspondence from a user on a social media network that utilizes a hashtag. The computer program product may also include program instructions to identify a subject and a location associated with the received correspondence using a plurality of natural language processing techniques. The computer program product may further include program instructions to identify a target audience for the received correspondence based on the identified subject and the identified location. The computer program product may also include program instructions to transmit the received correspondence to each individual within the identified target audience.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is a block diagram of a social media audience targeting program according to at least one embodiment;

FIG. 3 is an operational flowchart illustrating a social media audience targeting process according to at least one embodiment;

FIG. 4 is a block diagram of transmitting a social media message to a target audience according to at least one embodiment;

FIG. 5 is a block diagram of internal and external components of computers and servers depicted in FIG. 1 according to at least one embodiment;

FIG. 6 depicts a cloud computing environment according to an embodiment of the present invention; and

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention are related to the field of computing, and more particularly to social media. The following described exemplary embodiments provide a system, method, and program product to, among other things, utilize information within a social media message to target message recipients within a social media network based on the geographic location of each recipient. Therefore, the present embodiment has the capacity to improve the technical field of social media by implementing a system to distribute a social media message to members of a social media network so the message is only visible to social media network members within the geographic region within which the message is directed or as otherwise desired by the user posting the message.

As previously described, social media may be a computer-related tool that allows users to interact through the exchange of information, such as videos, images, hyperlinks, and text, across the Internet. A social media service, or social networking service, may relate to a platform, such as an instant messaging service, a short messaging service, a blog, a website, or a community, that allows individuals within a social network to interact. Some social media services allow users to post content with a hashtag which allows for easier location of the posted content by users with similar interests. A hashtag is a metadata tag typically used by a social media service to group related user posts together.

Typically, messages sent within a social network are distributed to followers or friends of the message sender. If the message sender wishes to indicate a message is related to a particular region, audience, or event, the message sender may include a hashtag within the message. For example, if the message sender wanted to indicate that the message would be of interest to friends or followers within the Washington D.C. area, the sent message may include the text “#DC.” However, even if a hashtag is included within a message, the message would be visible to all friends and followers of the message sender regardless of whether the message applies to a particular friend or follower's geographic region or interest. For example, in the previous example, the message with the “#DC” hashtag would be visible to all of the message sender's friends and followers even if some friends or followers of the message sender do not reside within the Washington D.C. area. As such, it may be advantageous, among other things, to implement a system that identifies a target audience for a particular social media message based on text within the sent message, and transmits the message only to the target audience.

According to one embodiment, when a social media message is sent by a user, information, such as text, within the sent message may be analyzed to identify a geographic location associated with the social media message. For example, if the message relates to a business conference, the location of the conference may be determined. The identified geographic location may then be associated with the message and distribution of the message may be limited to friends or followers of the user close to the identified geographic location even when the message sender is not located in the identified geographic location when the message is sent. For example, if a user sends a message from San Francisco that references an event taking place in Washington D.C., the target audience may be identified as friends and followers of the user located within or visiting the Washington D.C. area. Therefore, the scope of the message recipients may be dynamically adjusted so that only friends and followers within the Washington D.C. area receive the sent message. In at least one embodiment, the identified target audience may be friends or followers that share common interests as the message sender. For example, in the previous scenario, a friend or follower of the message sender may not be located within the Washington D.C. area but may be attending the event referenced by the message sender. Therefore, the particular friend or follower may be included in the target audience to which the message is distributed.

The following described exemplary embodiments provide a system, method, and program product that identifies a target audience for a social media message based on information within the transmitted message. The message may then be distributed only to members of the target audience rather than all friends or followers of the message sender.

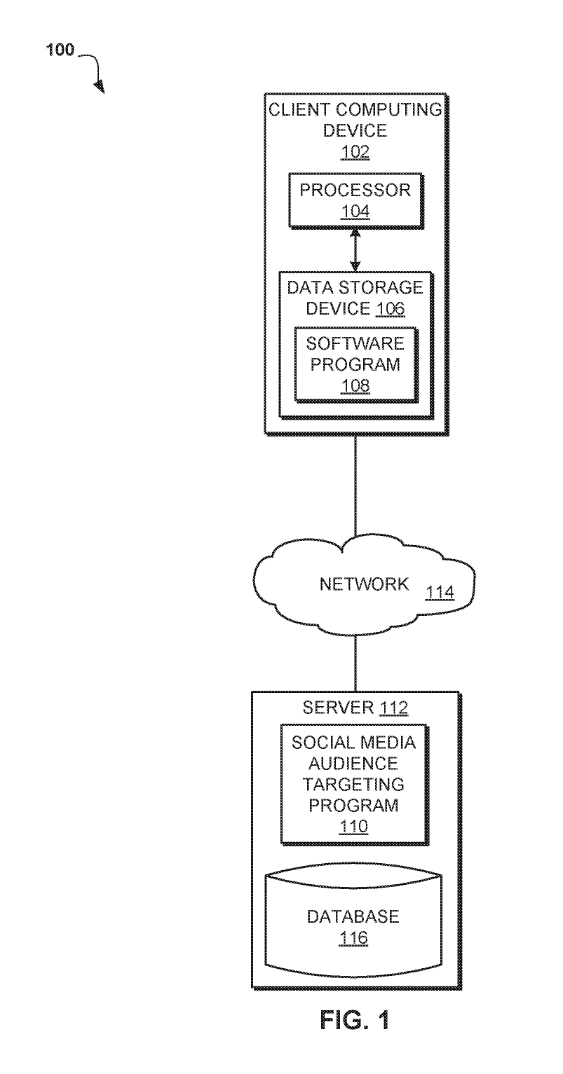

Referring to FIG. 1, an exemplary networked computer environment 100 is depicted, according to at least one embodiment. The networked computer environment 100 may include a client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

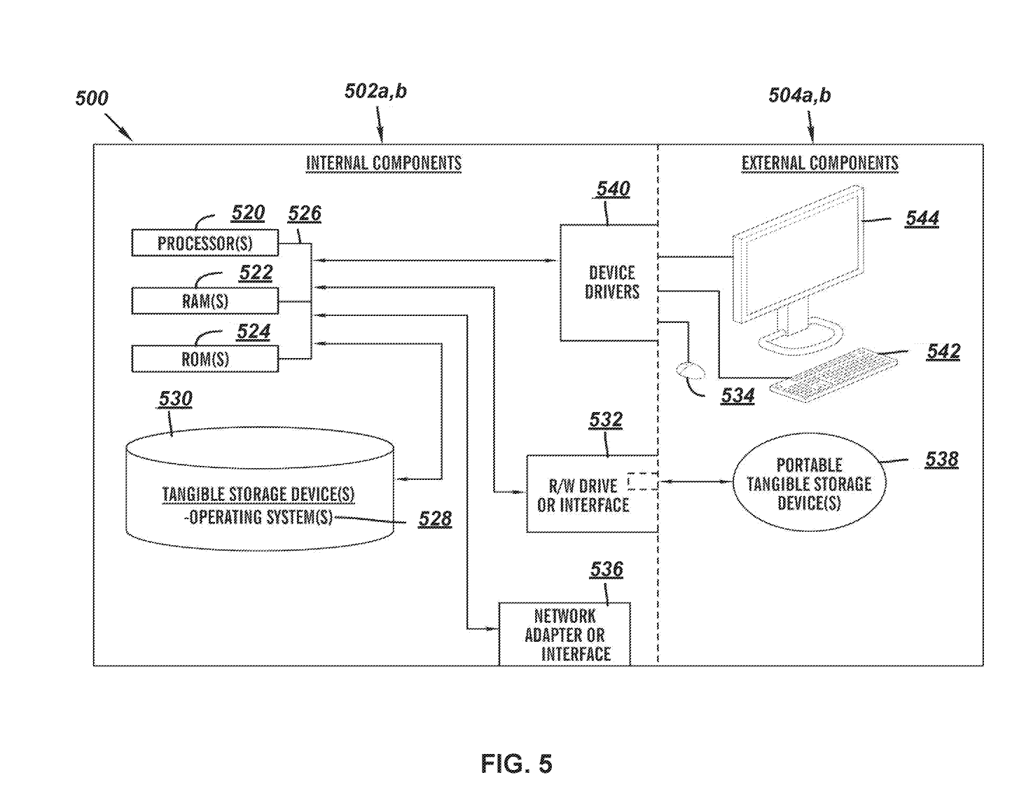

The client computing device 102 may include a processor 104 and a data storage device 106 that is enabled to host and run a software program 108 and communicate with the server 112 via the communication network 114, in accordance with one embodiment of the invention. The client computing device 102 may be, for example, a mobile device, a telephone, a personal digital assistant, a netbook, a laptop computer, a tablet computer, a desktop computer, or any type of computing device capable of running a program and accessing a network. Additionally, client computing device 102 and the software program 108 may be capable of communicating with the server 112 to identify a location of the client computing device. As will be discussed with reference to FIG. 5, the client computing device 102 may include internal components 502a and external components 504a, respectively.

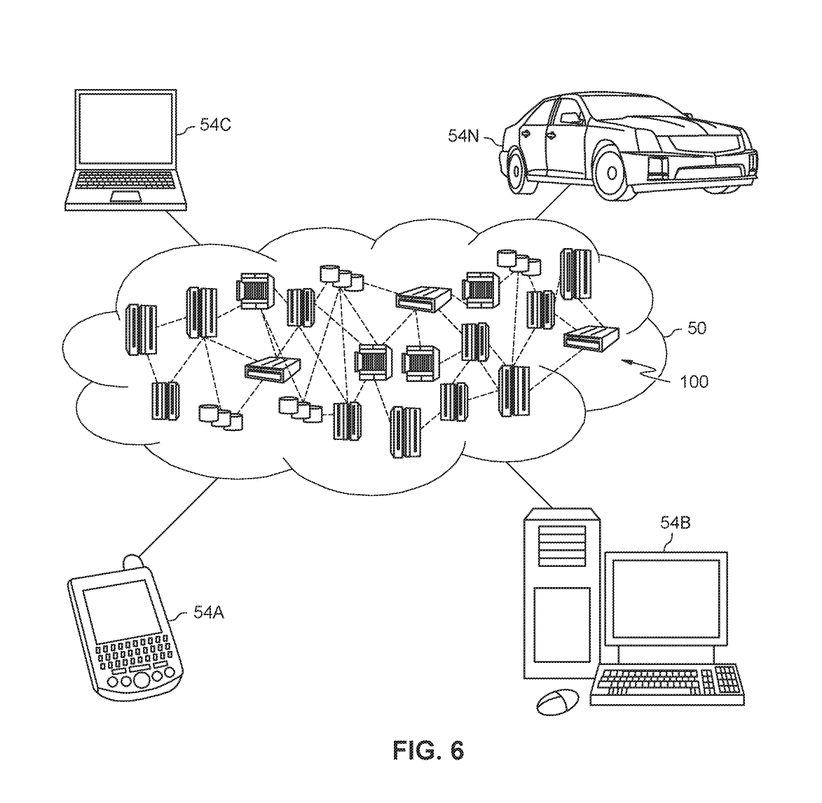

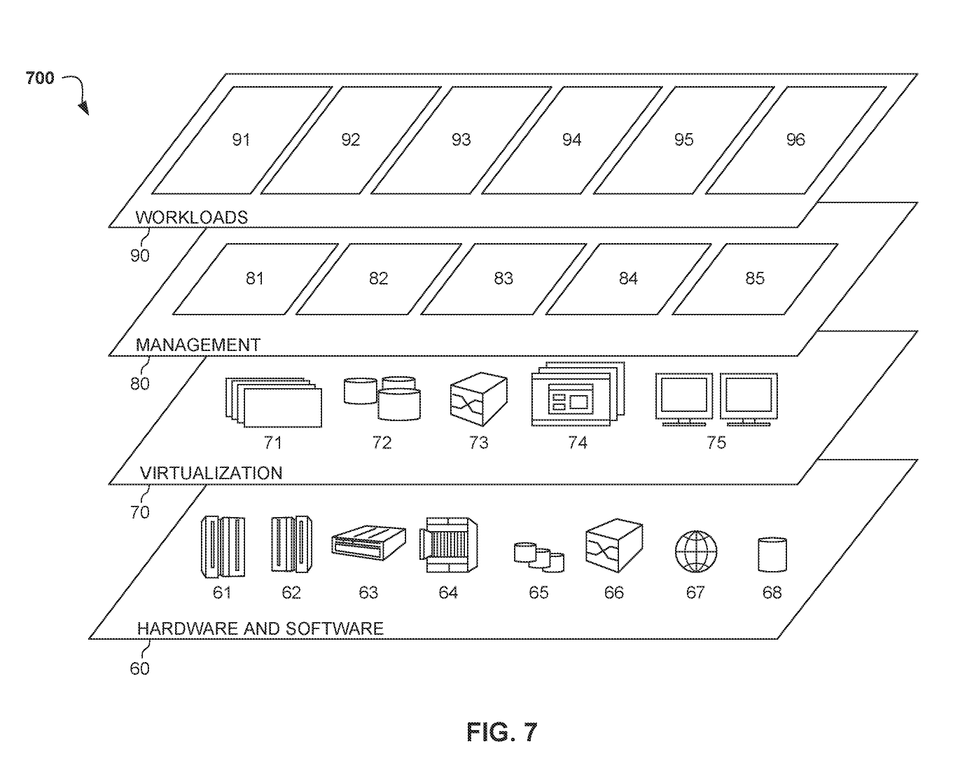

The server computer 112 may be a laptop computer, netbook computer, personal computer (PC), a desktop computer, or any programmable electronic device or any network of programmable electronic devices capable of hosting and running a social media audience targeting program 110 and a database 116 and communicating with the client computing device 102 via the communication network 114, in accordance with embodiments of the invention. As will be discussed with reference to FIG. 5, the server computer 112 may include internal components 502b and external components 504b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud. The cloud computing environment will be discussed in further detail below with respect to FIGS. 6 and 7.

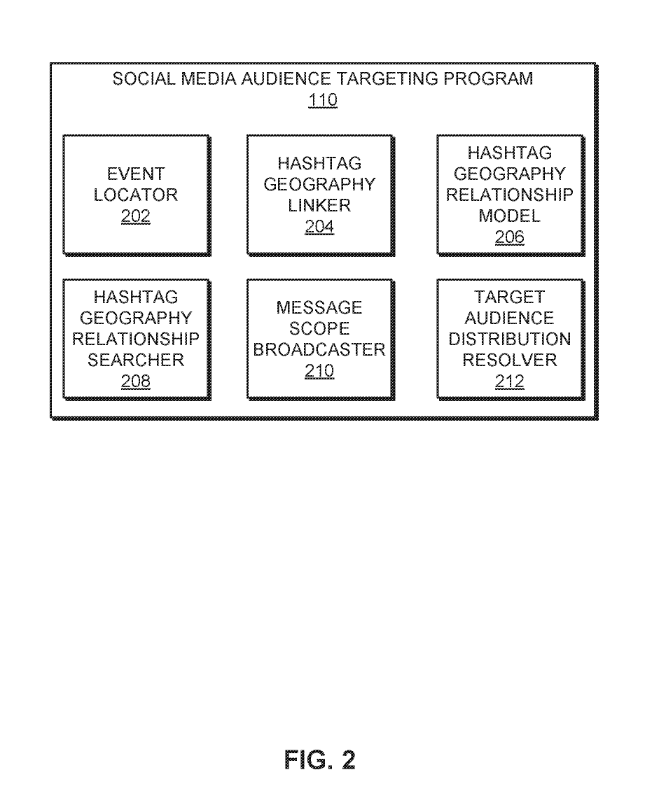

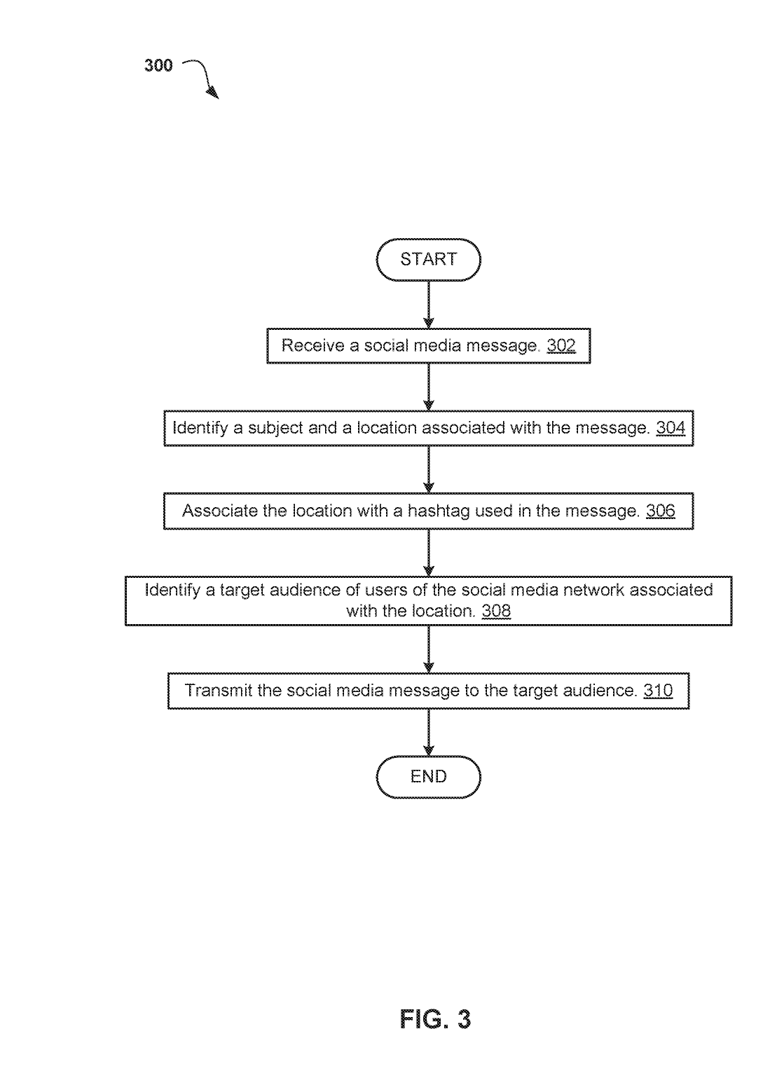

According to the present embodiment, the social media audience targeting program 110 may be a program capable of identifying a target audience for a social media message based on information, such as text or images, included within the message and distributing the message to the identified target audience. The text within the message used to identify the target audience by the social media audience targeting program 110 may reference a geographic location, an event, a common interest, or any other item that may be used to group together friends or followers of the message sender. Components of the social media audience targeting program 110 are explained in further detail with respect to FIG. 2. The social media audience targeting method is explained in further detail below with respect to FIG. 3.

Referring now to FIG. 2, a block diagram of a social media audience targeting program is depicted, according to at least one embodiment. The social media audience targeting program 110 may include an event locator 202, a hashtag geography linker 204, a hashtag geography relationship model 206, a hashtag geography relationship searcher 208, a message scope broadcaster 210, and a target audience distribution resolver 212.

The event locator 202 may be a component capable of mining data from a social media message to identify references to a public or private subject or event within the social media message. The event locator 202 may search for the identified reference in a variety of sources, such as a calendar, a web search, company information directory, or a data repository (e.g. database 116), for details of the event, such as date and location. The event locator 202 may query the client computing device 102 for the location of the user when the user sends a social media message.

The hashtag geography linker 204 may link a hashtag mentioned in the social media message with the geographical location of the subject or event. For example, if a user sends a message that references an event that takes place in Washington D.C. and utilizes a hashtag, such as “#event,” the hashtag geography linker 204 may associate the “#event” hashtag mentioned in the message with the particular event taking place in Washington D.C. or associate the “#event” hashtag directly with the location.

The hashtag geography relationship model 206 may be a data repository, such as database 116, capable of storing information detailing hashtag and geographical location relationships. For example, the hashtag geography relationship model 206 may be a table with column headings that include an event name, a hashtag associated with an event, an event location, an event date, and an event type (e.g. public or private). Once hashtag information has been linked by the hashtag geography linker 204, the hashtag information may be stored within the hashtag geography relationship model 206 on which subsequent queries may be executed.

The hashtag geography relationship searcher 208 may be a component capable of querying the hashtag geography relationship model 206 to search for hashtag information related to a particular area or event. For example, if a user sends a social media message that uses a hashtag associated with a particular event, the hashtag geography relationship searcher 208 may query the hashtag geography relationship model 206 for the hashtag information associated with the particular event.

The target audience distribution resolver 212 may generate the distribution list of the target audience. For example, hashtag geography relationship searcher 208 may identify the event mentioned within the user's social network message is associated with the hashtag “#event” and the location is “Washington D.C.” The target audience distribution resolver 212 can identify a list of social network users that are near the proximity of the Washington D.C. area who are attending the event, interested in the event, or subscribe to the hashtag “#event,” regardless of whether they are following the user or not. When a user posts a message in a social network, a query may be executed to identify the target audience distribution list. The target audience distribution resolver 212 may search the hashtag geography relationship model 206 for stored information of existing hashtag and geographical location relationships. If the query is the first query to be executed for a specific hashtag, then the target audience distribution resolver 212 may not locate any stored information within the hashtag geography relationship model 206.

The message scope broadcaster 210 may be capable of broadcasting the user message to a target audience that may be interested in the related hashtag. As previously described, the target audience distribution list may be generated by the target audience distribution resolver 212. For example, the target audience distribution list may include individuals who are within a specific distance of a geographic location of an event associated with a hashtag or individuals who follow or subscribe to a hashtag.

Referring now to FIG. 3, an operational flowchart illustrating a social media audience targeting process 300 is depicted, according to at least one embodiment. At 302, the social media audience targeting program 110 receives a social media message. A user may compose a social media message, such as a wall post, tweet, image caption, video caption, or any other type of social media correspondence, to transmit to friends and/or followers. The composed social media message may describe a subject, such as an event, a location, or a topic. Furthermore, the composed social media message may include a hashtag, a hyperlink, an image, a video, or any other supporting characteristic. The supporting characteristics (e.g. hashtag or image) may be used to highlight the subject of the message or some other item of importance.

Then, at 304, the social media audience targeting program 110 identifies a subject and a location associated with the message. The subject of the message may be any category of interest to the user (e.g. an event, a location, or a topic). The social media audience targeting program 110 may identify the subject by implementing known natural language processing techniques, such as machine learning. If the subject of the message is identified as a location, the social media audience targeting program 110 may identify the location as the same as the subject. For example, the user may be eating at a popular restaurant in Miami, Fla. and append the message with the text “Miami.” In such a situation, the social media audience targeting program 110 may identify both the subject and the location as “Miami.” If the social media audience targeting program 110 identifies the subject associated with the message as an event, the social media audience targeting program 110 may utilize the event locator 202 to determine characteristics of the event, including the event location. As previously described, the event locator 202 may search for the identified reference in a variety of sources, such as a calendar, a web search, company information director, or a data repository (e.g. database 116), for details of the event, such as date and location. Additionally, the social media audience targeting program 110 may identify the subject of the message as a topic relevant to the user composing the social media message. For example, the user may include text describing the user's favorite movie or the user's favorite basketball team. Since some topics may not be related to a specific location, the social media audience targeting program 110 may identify all locations as associated with the message when a topic is not about an event or activity.

Furthermore, the social media audience targeting program 110 may identify the subject of the message immediately upon one receiving the composed message, if the message can be obviously mapped to the subject. For example, the social media audience targeting program 110 may map a message with the text “Miami Beach is so beautiful today” to a subject of “Miami” immediately since the text may relate to the city of Miami. If the social media audience targeting program 110 is unable to clearly identify a subject immediately, the social media audience targeting program 110 may wait until a preconfigured number of users utilize the similar language so that the context in which the text is used may be analyzed with known natural language processing techniques to determine the subject. For example, if the user includes the hashtag “#blue” in a message, the social media audience targeting program 110 may not be able to determine the subject of the message since the hashtag “#blue” is generic. However, if the social media audience targeting program 110 analyzes social media messages from other users, the social media audience targeting program 110 may determine that the hashtag “#blue” is commonly use to describe a music festival titled “Bluebird Festival” in Phoenix, Ariz. The social media audience targeting program 110 may then associate hashtag “#blue” and the user's message with the location Phoenix, Ariz.

Then, at 306, the social media audience targeting program 110 associates the identified location with a hashtag used in the message. The social media audience targeting program 110 may associate the hashtag with the identified location and other hashtags associated with the identified location. For example, if the hashtag subject relates to an event located in Washington D.C., the social media audience targeting program 110 may associate the hashtag for the event with a hashtag related to the Washington D.C. location, such as “#DC.” In at least one embodiment, the social media audience targeting program 110 may prompt the user to confirm the association between the identified subject and identified location through user interactions with a graphical user interface.

Next, at 308, the social media audience targeting program 110 identifies a target audience of users of the social media network associated with the location. As previously described, the social media network may be an instant messaging service, a short messaging service, a blog, a website, or a community. The social media audience targeting program 110 may identify a target audience by identifying users of the social media network who are associated with the location. For example, if the identified location of the hashtag or the subject of the message is Washington D.C., the social media audience targeting program 110 may identify users who live in, are currently located in or around, or recently visited the Washington D.C. area. Furthermore, if the subject is an event, the social media audience targeting program 110 may identify a user as being in the target audience if the user will be travelling to the identified location during the time frame in which the identified event will occur. For example, if a user has indicated travel plans to Washington D.C. during the identified event, the user may be included in the target audience. The social media audience targeting program 110 may be able to determine a user's travel plans by analyzing a calendar or a social media profile for the user. Additionally, the social media audience targeting program 110 may identify an individual as a member of the target audience if the individual has subscribed to a hashtag related to the identified subject and/or location. For example, an individual may be subscribed to “#DC.” Furthermore, the user posting the social media message may preconfigure individuals for the social media audience targeting program 110 to include in the target audience based on user interactions with a graphical user interface associated with a user device, such as the client computing device 102. For example, a client computing device 102, such as a smartphone, may capture the user's recent activities in Washington D.C. The social media audience targeting program 110 may query the client computing device 102 on the device's location to determine if the user is in a target audience. Additionally, once identified, the social media audience targeting program 110 may store the target audience in the hashtag geography relationship model 206 for later use by the social media audience targeting program 110 when a subsequent social media message uses the same hashtag. Furthermore, the identified target audience may include user accounts associated with individual users of the social media network.

As an additional example, if a user posts a social media message using a hashtag that is identified as relating to an event taking place in Washington D.C., the posted social media message may be sent to individuals who are located in or visiting the Washington D.C. area, individuals who are attending other events in the Washington D.C. area at the same time as the event in the user's post, and/or individuals that posted messages about Washington D.C. The identified target audience may be a subset of the user's followers or users that do not currently follow the user.

Then, at 310, the social media audience targeting program 110 transmits the social media message to the target audience. Once the target audience is identified in step 308, the social media audience targeting program 110 may transmit (i.e. broadcast) the social media message to the user account associated with each individual within the identified target audience. Therefore, any individuals of the social network that are not in the target audience may not receive the posted message. In at least one embodiment, the social media audience targeting program 110 may display subsequent social media messages posted by the user about the subject only to the target audience. For example, if the user posts an original message that uses a hashtag related to an event in the Washington D.C. area for which a target audience was identified, any subsequent social media messages utilizing the same hashtag related to the event may only be broadcast to the previously identified target audience. Since the target audience has already been identified and the relationships among the subject of the event, hashtags used in the message, and the location of the event are stored within the hashtag geography relationship model 206, the social media audience targeting program 110 may search social network participants from the social network provider based on the hashtag geography relationship model 206 for the corresponding target audience when a particular hashtag is used in a subsequent social media message. For example, if the user posts an original message on a social network that is determined to relate to an event in the Washington D.C. area for which a target audience is identified, then the social media audience targeting program 110 may query the social media network's user directory to generate a target audience distribution list dynamically based on the hashtag geography relationship model 206 for the message.

In at least one other embodiment, if the user posts a social media message about an approaching event, the social media audience targeting program 110 may periodically broadcast the posted social media message to the target audience. Furthermore, once the event occurs, the social media audience targeting program 110 may cease the scope adjustment of the posted message so the scope is no longer reduced to the target audience.

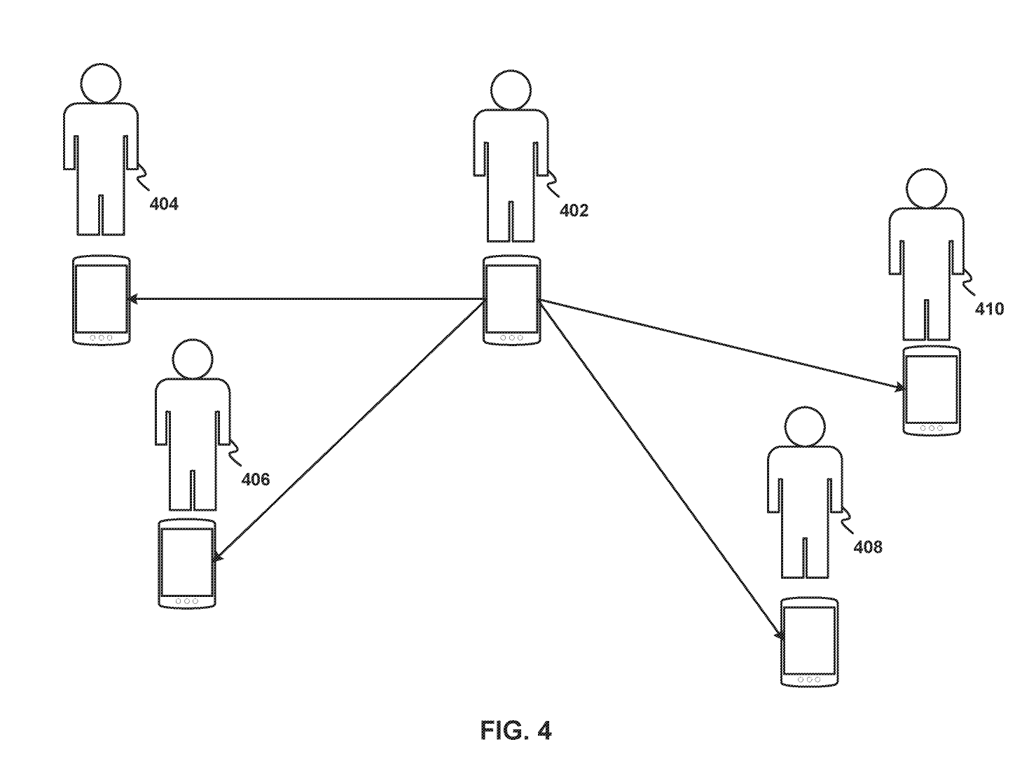

Referring now to FIG. 4, a block diagram of transmitting a social media message to a target audience is depicted, according to at least one embodiment. User A 402 sends a message that discusses an event and uses the hashtag “#eventX” using a client computing device 102, such as a smartphone. User A 402 may have four followers 404-410. Two of User A's followers (i.e. Follower A 404 and Follower B 406) may be located in Austin, Tex. while the rest of User A's followers (i.e. Follower C 408 and Follower D 410) may be located in Washington D.C. Without implementing the social media audience targeting program 110, all four of User A's followers 404-410 would receive the message regardless of whether the event of which User A 402 posted is relevant to each follower. Through known natural language processing techniques, the social media audience targeting program 110 may identify the location of the event as Washington D.C. The social media audience targeting program 110 may identify a target audience, and only display User A's message on a news feed associated with Follower C 408 and Follower D 410. Since Follower A 404 and Follower B 406 are not included within the target audience due to their physical locations in Austin, Tex., User A's message may not be displayed on the news feed associated with Follower A 404 and Follower B 406.

It may be appreciated that FIGS. 2, 3, and 4 provide only an illustration of one implementation and do not imply any limitations with regard to how different embodiments may be implemented. Many modifications to the depicted environments may be made based on design and implementation requirements.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 5 is a block diagram 500 of internal and external components of the client computing device 102 and the server 112 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 502 a,b and external components 504 a,b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the software program 108 in the client computing device 102 and the social media audience targeting program 110 in the server 112 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502 a,b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the social media audience targeting program 110, can be stored on one or more of the respective portable computer-readable tangible storage devices 538, read via the respective R/W drive or interface 532, and loaded into the respective hard drive 530.

Each set of internal components 502 a,b also includes network adapters or interfaces 536 such as a TCP/IP adapter cards, wireless Wi-Fi interface cards, or 3G or 4G wireless interface cards or other wired or wireless communication links. The software program 108 in the client computing device 102 and the social media audience targeting program 110 in the server 112 can be downloaded to the client computing device 102 and the server 112 from an external computer via a network (for example, the Internet, a local area network or other, wide area network) and respective network adapters or interfaces 536. From the network adapters or interfaces 536, the software program 108 in the client computing device 102 and the social media audience targeting program 110 in the server 112 are loaded into the respective hard drive 530. The network may comprise copper wires, optical fibers, wireless transmission, routers, firewalls, switches, gateway computers and/or edge servers.

Each of the sets of external components 504 a,b can include a computer display monitor 544, a keyboard 542, and a computer mouse 534. External components 504 a,b can also include touch screens, virtual keyboards, touch pads, pointing devices, and other human interface devices. Each of the sets of internal components 502 a,b also includes device drivers 540 to interface to computer display monitor 544, keyboard 542, and computer mouse 534. The device drivers 540, R/W drive or interface 532, and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 100 and cloud computing environment 50 can communicate with any type of computerized device over any type of network and/or network addressable connection (e.g., using a web browser).

Referring now to FIG. 7, a set of functional abstraction layers 700 provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and adjusting social media message scope 96. Adjusting social media message scope 96 may relate to leveraging a hashtag included within a posted social media message to identify a target audience that is most likely to be interested in the posted social media message. Furthermore, the posted social media message may only be broadcast to the news feeds associated with each member of the identified target audience.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for identifying a plurality of recipients of a social media correspondence, the method comprising:
receiving, by a processor, a social media network correspondence that includes user-entered content from a client computing device, wherein the user-entered content comprises a hashtag;
identifying a subject and a geographic location associated with the received correspondence using a plurality of natural language processing techniques;
identifying a target audience for the received correspondence based on the identified subject and the identified geographic location, wherein the target audience comprises at least one user account; and
transmitting the received correspondence over a network to each user account associated with the identified target audience.

2. The method of claim 1,
further comprising:
connecting the received correspondence with the identified geographic location and at least one other hashtag associated with the identified geographic location; and
storing the connected correspondence in a data repository;
and wherein identifying the target audience further comprises:
identifying the target audience based on the stored correspondence in the data repository.

3. The method of claim 1, wherein the hashtag is associated with a category of interest, and wherein the category of interest is selected from a group consisting of an event, a location, and a topic.

4. The method of claim 1, wherein the target audience is selected from a group consisting of a plurality of individuals associated with a geographic location, a plurality of individuals associated with an event, a plurality of subscribers to the hashtag, a plurality of friends of the user, a plurality of followers of the user.

5. The method of claim 4, wherein the group is selected through a plurality of user interactions with a graphical user interface.

6. The method of claim 3, wherein, in response to the category of interest being an event, once the event has occurred, adjusting a scope of the target audience to include all of a plurality of individuals that are a friend or a follower of the user on the social media network.

7. The method of claim 1, wherein the social media network is selected from a group consisting of an instant messaging service, a short messaging service, a blog, a website, and a community.

8. A computer system for identifying a plurality of recipients of a social media correspondence, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a social media network correspondence that includes user-entered content from a client computing device, wherein the user-entered content comprises a hashtag;
identifying a subject and a geographic location associated with the received correspondence using a plurality of natural language processing techniques;
identifying a target audience for the received correspondence based on the identified subject and the identified geographic location, wherein the target audience comprises at least one user account; and
transmitting the received correspondence over a network to each user account associated with the identified target audience.

9. The computer system of claim 8,
further comprising:
connecting the received correspondence with the identified geographic location and at least one other hashtag associated with the identified geographic location; and
storing the connected correspondence in a data repository;
and wherein identifying the target audience further comprises:
identifying the target audience based on the stored correspondence in the data repository.

10. The computer system of claim 8, wherein the hashtag is associated with a category of interest, and wherein the category of interest is selected from a group consisting of an event, a location, and a topic.

11. The computer system of claim 8, wherein the target audience is selected from a group consisting of a plurality of individuals associated with a geographic location, a plurality of individuals associated with an event, a plurality of subscribers to the hashtag, a plurality of friends of the user, a plurality of followers of the user.

12. The computer system of claim 11, wherein the group is selected through a plurality of user interactions with a graphical user interface.

13. The computer system of claim 10, wherein, in response to the category of interest being an event, once the event has occurred, adjusting a scope of the target audience to include all of a plurality of individuals that are a friend or a follower of the user on the social media network.

14. The computer system of claim 8, wherein the social media network is selected from a group consisting of an instant messaging service, a short messaging service, a blog, a website, and a community.

15. A computer program product for identifying a plurality of recipients of a social media correspondence, the computer program product comprising:
one or more computer-readable tangible storage medium and program instructions stored on at least one of the one or more tangible storage medium, the program instructions executable by a processor, the program instructions comprising:
program instructions to receive a social media network correspondence that includes user-entered content from a client computing device, wherein the user-entered content comprises a hashtag;
program instructions to identify a subject and a geographic location associated with the received correspondence using a plurality of natural language processing techniques;
program instructions to identify a target audience for the received correspondence based on the identified subject and the identified geographic location, wherein the target audience comprises at least one user account; and
program instructions to transmit the received correspondence over a network to each user account associated with the identified target audience.

16. The computer program product of claim 15,
further comprising:
connecting the received correspondence with the identified geographic location and at least one other hashtag associated with the identified geographic location; and
storing the connected correspondence in a data repository;
and wherein identifying the target audience further comprises:
identifying the target audience based on the stored correspondence in the data repository.

17. The computer program product of claim 15, wherein the hashtag is associated with a category of interest, and wherein the category of interest is selected from a group consisting of an event, a location, and a topic.

18. The computer program product of claim 15, wherein the target audience is selected from a group consisting of a plurality of individuals associated with a geographic location, a plurality of individuals associated with an event, a plurality of subscribers to the hashtag, a plurality of friends of the user, a plurality of followers of the user.

19. The computer program product of claim 18, wherein the group is selected through a plurality of user interactions with a graphical user interface.

20. The computer program product of claim 17, wherein, in response to the category of interest being an event, once the event has occurred, adjusting a scope of the target audience to include all of a plurality of individuals that are a friend or a follower of the user on the social media network.
